(19) United States
(12) Patent Application Publication
(10) Pub. No.: US 2026/0292084 A1
(43) Pub. Date: Sep. 24, 2026

(54) DOCUMENT READER AND IMAGE FORMING SYSTEM

(71) Applicant: FUJIFILM Business Innovation Corp., Tokyo (JP)

(72) Inventor: Takayuki SUEHIRO, Kanagawa (JP)

(73) Assignee: FUJIFILM Business Innovation Corp., Tokyo (JP)

(21) Appl. No.: 19/282,154

(22) Filed: Jul. 28, 2025

(30) Foreign Application Priority Data
Mar. 24, 2025 (JP) 2025-048954

(51) Int. Cl. H04N 1/00; B41J 3/44; G03G 15/22; H04N 1/23

(52) U.S. Cl. CPC H04N 1/00594; H04N 1/0079; H04N 1/00816; H04N 1/00976; H04N 1/233; B41J 3/44; G03G 15/228

(57) ABSTRACT

A document reader includes: a document bed having a reading part that reads a document; a document feeder that is supported by the document bed so as to be capable of opening and closing an upper surface of the document bed and that feeds the document along a transport path passing through a reading area of the reading part; a first guide part that is provided in the document feeder and located downstream of the reading area in the transport path and that guides the document downstream along the transport path; and a second guide part that is provided on the upper surface of the document bed and located between the reading area and the first guide part in the transport path, that overlaps the first guide part when viewed in a main scanning direction, and that guides the document to the first guide part.

### CROSS-REFERENCE TO RELATED APPLICATIONS

This application is based on and claims priority under 35 USC 119 from Japanese Patent Application No. 2025-048954 filed Mar. 24, 2025.

### BACKGROUND

### (i) Technical Field

The present disclosure relates to a document reader and an image forming system.

### (ii) Related Art

Japanese Unexamined Patent Application Publication No. 2005-142995 discloses a sheet transport device. The sheet transport device includes a first guide member, a second guide member, and transport rollers. The first guide member is disposed on an upstream side in a sheet transport direction. The first guide member has a curved shape. The first guide member has an outlet opening. The second guide member is disposed downstream of the first guide member in the sheet transport direction. The second guide member has an inlet opening that is wider than the outlet opening. The transport rollers are disposed downstream of the inlet opening of the second guide member in the sheet transport direction. The transport rollers include a pair of rollers that nip and convey the sheet. In the sheet transport device, the sheet having passed through the outlet opening of the first guide member passes through the inlet opening of the second guide member and is then transported by the transport rollers. In this sheet transport device, the sheet between the outlet opening of the first guide member and the inlet opening of the second guide member is positioned on the common tangent of the transport rollers.

Japanese Unexamined Patent Application Publication No. 2004-250170 discloses a document transport device. The document transport device includes a switchback path and switching gates. The switchback path includes a first transport path for reversing a document and extending in a predetermined direction and a second transport path extending in a direction different from the first transport path. The switching gates are disposed on the entrance side of the first transport path and the exit side of the second transport path. The switching gates are switched by a document transport force. There are multiple switching gates arranged in a direction perpendicular to the transport direction. Furthermore, the lengths of the multiple switching gates are unequal.

Japanese Unexamined Patent Application Publication No. 2004-250171 discloses a document transport device. The document transport device includes a first transport path for reversing a document and extending in a predetermined direction and a second transport path extending in a direction different from the first transport path. Switching gates are disposed on the entrance side of the first transport path and the exit side of the second transport path. The switching gates are switched by a document transport force. In the document transport device, multiple ribs extending in the transport direction are formed on a transport path member facing one of the switching gates. In the document transport device, the heights of the multiple ribs at the position where the document comes into contact with a transport path surface of the transport path member are varied.

### SUMMARY

Aspects of non-limiting embodiments of the present disclosure relate to suppressing noise generated during feeding of a document, compared with a configuration in which a first guide part provided in a document feeder and a second guide part provided in a document bed are separated from each other when viewed in a main scanning direction in a state in which the document feeder is closed with respect to the document bed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a document reader including: a document bed having a reading part that reads a document; a document feeder that is supported by the document bed so as to be capable of opening and closing an upper surface of the document bed and that feeds the document along a transport path passing through a reading area of the reading part; a first guide part that is provided in the document feeder and located downstream of the reading area in the transport path and that guides the document downstream in the transport path; and a second guide part that is provided on the upper surface of the document bed and located between the reading area and the first guide part in the transport path, that overlaps the first guide part when viewed in a main scanning direction, and that guides the document to the first guide part.

### BRIEF DESCRIPTION OF THE DRAWINGS

Exemplary embodiments of the present disclosure will be described in detail based on the following figures, wherein:

FIG. 1 is a perspective view illustrating a state in which a document feeder is open with respect to a document bed in a document reader according to an exemplary embodiment of the present disclosure;

FIG. 2 schematically illustrates the document reader illustrated in FIG. 1;

FIG. 3 is an enlarged view of a portion indicated by arrow 3X in FIG. 2;

FIG. 4 is a plan view of a first guide part and a second guide part as viewed in a direction indicated by arrow 4X in FIG. 3;

FIG. 5 is a plan view of the second guide part illustrated in FIG. 4;

FIG. 6 is a plan view of a first guide part and a second guide part of a document reader according to another exemplary embodiment of the present disclosure; and

FIG. 7 is a plan view of the second guide part illustrated in FIG. 6.

### DETAILED DESCRIPTION

Hereinbelow, an image forming apparatus, which is an example of a document reader and an image forming system according to an exemplary embodiment of the present disclosure, will be described with reference to the drawings.

### Image Forming Apparatus

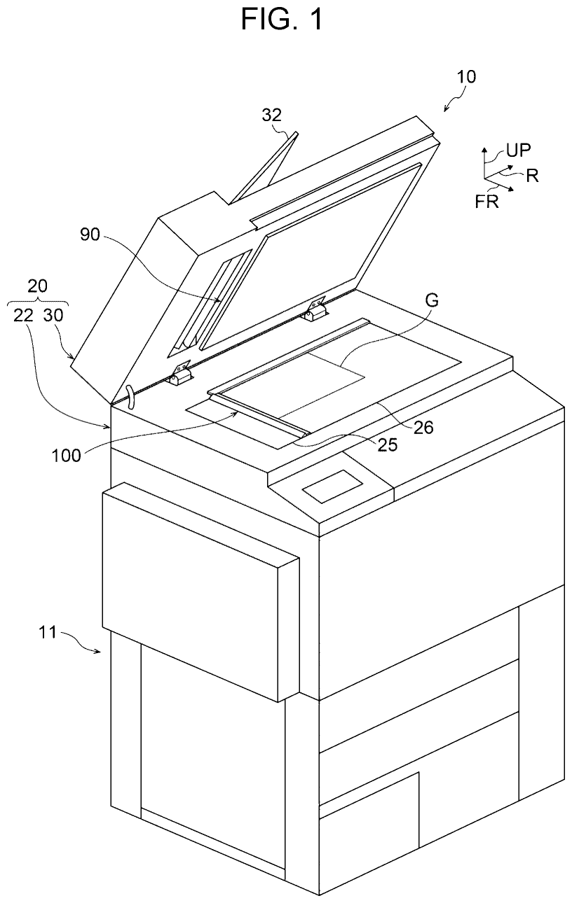

An image forming apparatus 10 according to an exemplary embodiment will be described. FIG. 1 is a perspective view of the image forming apparatus 10.

In FIG. 1 and other figures, arrow UP indicates an upward direction (vertically upward direction) of the apparatus. Hence, the direction opposite to arrow UP is the downward direction (vertically downward direction) of the apparatus. In FIG. 1 and other figures, arrow FR indicates a forward direction of the apparatus. Hence, the direction opposite to arrow FR is a backward direction of the apparatus. In FIG. 1 and other figures, arrow RH indicates the rightward direction of the apparatus. Hence, the direction opposite to arrow RH is the leftward direction of the apparatus. These directions are defined for convenience of description, and the configuration of the apparatus is not limited to these directions.

The front-rear direction and the left-right direction of the apparatus may also be expressed as the lateral directions, the side directions, and the horizontal directions of the apparatus. In addition, the term “apparatus” may be omitted when referring to the directions of the apparatus. Specifically, for example, “the upward direction of the apparatus” may be simply referred to as “the upward direction”. In addition, in the drawings, the symbol “○” with “•” therein means an arrow pointing the near side with respect to the plane of the drawings.

In addition, the same or similar components are denoted by the same reference numerals across the drawings. In the following exemplary embodiments, redundant descriptions and reference numerals may be omitted. The drawings used in the following description are all schematic, and the dimensional relationship between elements, the ratio of elements, and the like illustrated in the drawings do not necessarily coincide with the actual ones. In addition, the dimensional relationships of the elements, the ratios of the elements, and the like do not necessarily coincide with one another among the drawings.

The image forming apparatus 10 illustrated in FIG. 1 forms an image. Specifically, as illustrated in FIG. 1, the image forming apparatus 10 includes an image forming apparatus body 11 and a document reader 20. Hereinbelow, the components of the image forming apparatus 10 will be described.

The image forming apparatus body 11 illustrated in FIG. 1 is provided with the components of the image forming apparatus 10. Specifically, the image forming apparatus body 11 includes a box-shaped housing.

The image forming apparatus body 11 includes a medium container, an image forming part, a transport mechanism, and a medium discharge part, which are not illustrated. The document reader 20 is provided at the upper end of the image forming apparatus body 11.

The medium container stores recording media (not illustrated), and a recording medium on which an image has been formed by the image forming part is discharged to the medium discharge part. The transport mechanism transports a recording medium from the medium container to the image forming part, and transports the recording medium on which an image has been formed by the image forming part from the image forming part to the medium discharge part.

The image forming part forms an image on a recording medium fed from the medium container. Examples of the image forming part include an inkjet image forming part that uses ink to form an image on a recording medium, and an electrophotographic image forming part that uses toner to form an image on a recording medium.

The inkjet image forming part forms an image on a recording medium by, for example, ejecting ink droplets from an ejecting part onto the recording medium. Alternatively, the inkjet image forming part may form an image on a recording medium by ejecting ink droplets from an ejecting part to a transfer body, and then transferring the ink droplets from the transfer body to the recording medium.

The electrophotographic image forming part forms an image on a recording medium by performing, for example, charging, exposure, development, transfer, and fixing. Alternatively, the electrophotographic image forming part may form an image on a recording medium by forming an image on a transfer member by performing charging, exposure, development, and transfer, transferring the image from the transfer member to the recording medium, and then fixing the image on the recording medium.

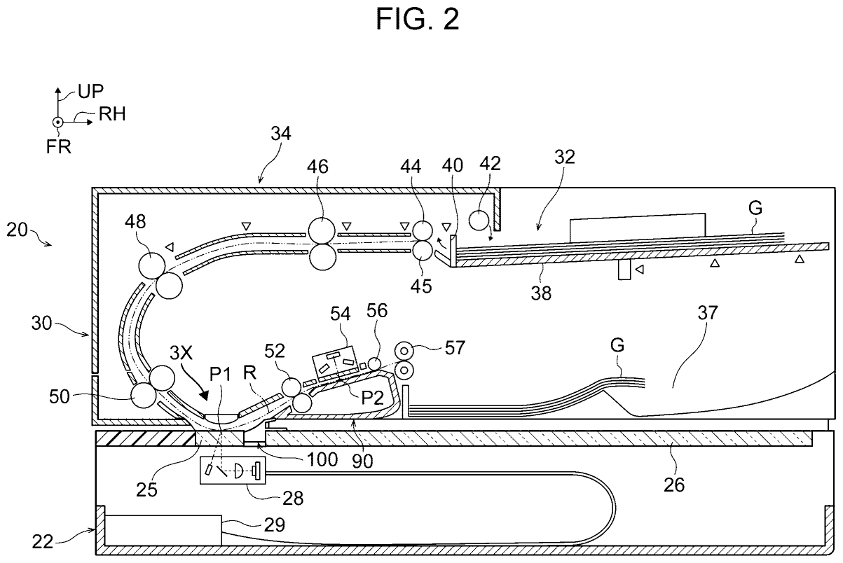

In the image forming apparatus 10, when an image of a document G (see FIG. 2) is copied, the image forming part forms, on a recording medium, an image read by a reading unit 28 and a reading sensor 54 (see FIG. 2), which is an example of a reading part described below, of the document reader 20.

An example of the image forming part is not limited to the inkjet image forming part and the electrophotographic image forming part described above, and various image forming parts may be used.

### Document Reader

FIG. 1 is a perspective view illustrating a state in which a document feeder 30, described below, of the document reader 20 is in an open position. FIG. 2 schematically illustrates the document reader 20.

As illustrated in FIG. 2, the document reader 20 reads an image on a document G. The document reader 20 includes a document bed 22, the document feeder 30, a transport guide 90, and a document guide 100.

### Document Bed 22

The document bed 22 has a box shape. The document feeder 30 is disposed on the upper surface of the document bed 22. The document feeder 30 is provided on the document bed 22 so as to be able to open and close the upper surface of the document bed 22. That is, the document feeder 30 is rotatably supported by the document bed 22.

A reading window 25 is disposed on the left side of the upper surface of the document bed 22. The document G transported by the document feeder 30 passes above the reading window 25. A platen glass 26 that supports the document G placed by the user is disposed to the right of the reading window 25. A body part 100A of the document guide 100, which is an example of a second guide part, is disposed between the reading window 25 and the platen glass 26. The document guide 100 guides the document G that has passed through the reading window 25 into the document feeder 30. Specifically, the document guide 100 guides the document G that has passed through the reading window 25 to the transport guide 90.

The reading unit 28, which is an example of a reading part, is disposed inside the document bed 22. The reading unit 28 is supported so as to be movable in the left-right direction, which is an example of a sub-scanning direction, along the lower surfaces of the reading window 25 and the platen glass 26. The reading unit 28 is normally stopped at an initial position illustrated in FIG. 2.

Inside the document bed 22, an image processing unit 29, which is an example of a processing unit, is disposed below the reading unit 28. The image processing unit 29 is electrically connected to the reading unit 28.

The image processing unit 29 converts RGB (red, green, and blue) electric signals input from the reading unit 28 into CMYK (cyan, magenta, yellow, and black) image data and temporarily stores the image data. The image processing unit 29 outputs, as the image data, the stored image data to the image forming part of the image forming apparatus body part 11 at a preset time.

### Document Feeder 30

The document feeder 30 includes a document feed tray 32, which is an example of a document stacking part, on which multiple documents G to be copied are stacked and accommodated. A document transport unit 34 is provided to the left of the document feed tray 32. The document transport unit 34 sends the document G along a transport path R passing through a reading area of the reading unit 28. A document discharge tray 37, which is an example of a document discharge part, is disposed below the document feed tray 32. The document G that has passed through the reading area is discharged from the document transport unit 34 to the document discharge tray 37. The transport path R is a path along which the document G on the document feed tray 32 is transported (sent) to the document discharge tray 37 through the reading area on the upper surface of the document bed 22.

The document feed tray 32 includes a feed tray body 38. The feed tray body 38 has a plate-like shape extending obliquely upward to the right.

A set gate 40, which is an example of an alignment member for aligning the documents G, is disposed at the left end of the document feed tray 32. The set gate 40 is rotatably supported. The set gate 40 is held suspended before the documents G are transported, and the leading ends of the documents G in the transport direction are abutted against the set gate 40 so that the documents G are aligned. When the documents G start to be transported, the set gate 40 is released and rotatable to the downstream side so as not to hinder the transport of the documents G.

A pickup roller 42, which is an example of a document pickup member, is disposed above and upstream of the set gate 40 in the transport direction of the documents G. The pickup roller 42 is movable in the up-down direction.

A transport roller 44, which is an example of a document transport member, is disposed downstream of the set gate 40. A separation roller 45, which is an example of a document separation member, is disposed below the transport roller 44 so as to face the transport roller 44.

A transport roller 46, which is an example of a document transport member having a skew correction function, is disposed downstream of the transport roller 44.

A transport roller 48, which is an example of a document transport member, is disposed downstream of the transport roller 46.

A transport roller 50, which is an example of a document transport member, is disposed downstream of the transport roller 48. The transport roller 50 adjusts the timing of transporting the document G toward a reading position P1, where a first side of the document G is to be read.

A transport roller 52, which is an example of a document transport member, is disposed downstream of the transport roller 50 and downstream of the reading position P1, where the first side is to be read. A reading position P2, where a second side of the document G is to be read, is set downstream of the transport roller 52. A reading sensor 54, which is an example of a second reading part, is disposed at the reading position P2 for the second side. The reading sensor 54 is a contact image sensor (CIS).

A reading roller 56, which is an example of a reading auxiliary member, is disposed downstream of the reading sensor 54. A discharge roller 57 for discharging the document G to the document discharge tray 37 is disposed downstream of the reading roller 56.

### Transport Guide 90

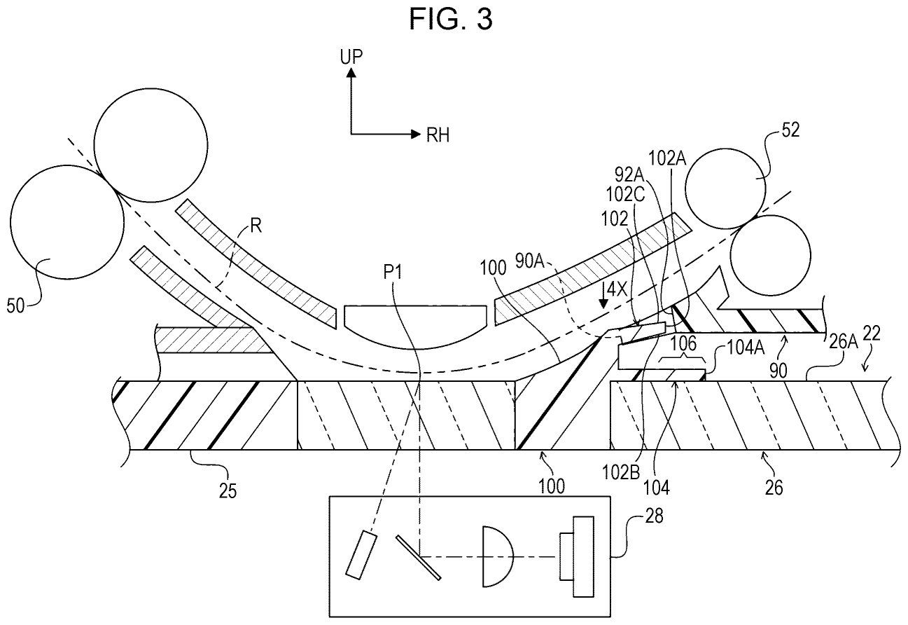

As illustrated in FIGS. 2 and 3, the transport guide 90 is provided in the document feeder 30. The transport guide 90 is located downstream of the reading area in the transport path R. In this exemplary embodiment, the reading position P1 is included in the reading area where the document G is read by the reading unit 28. The transport guide 90 guides the document G that has passed through the reading area to the downstream side of the transport path R. The transport guide 90 according to this exemplary embodiment is an example of a first guide part of the present disclosure.

### Document Guide 100

As illustrated in FIGS. 2 and 3, the document guide 100 is provided in the upper surface of the document bed 22. The document guide 100 is located between the reading area and the transport guide 90 in the transport path R. The document guide 100 guides the document G to the transport guide 90. The document guide 100 according to this exemplary embodiment is an example of a second guide part of the present disclosure.

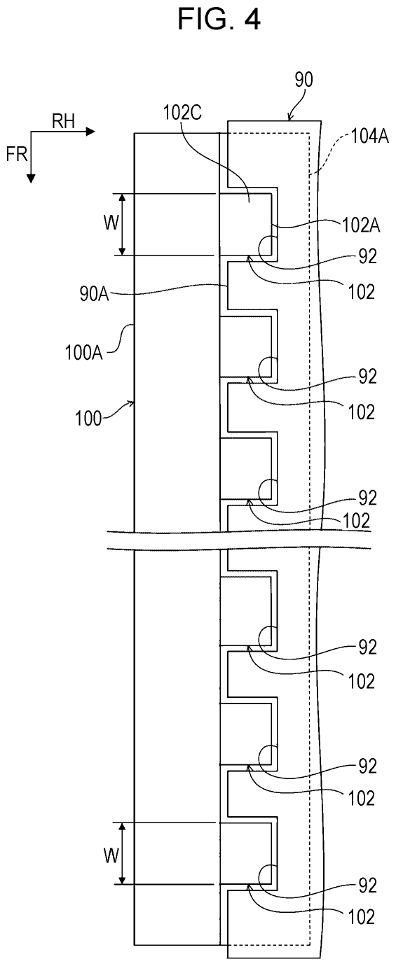

As illustrated in FIG. 3, the document guide 100 overlaps the transport guide 90 when viewed in the main scanning direction. Specifically, as illustrated in FIG. 4, the transport guide 90 has, at an upstream end 90A thereof in the transport path R direction, multiple notches 92 provided at intervals in the main scanning direction. The document guide 100 has plate-like extending portions 102 provided at intervals in the main scanning direction and extending toward the downstream side of the transport path R. In a state in which the document feeder 30 is closed, distal ends 102A of the extending portions 102 of the document guide 100 are accommodated in the notches 92 and overlap ends 90A of the transport guide 90 when viewed in the main scanning direction. The main scanning direction is a main scanning direction of the reading unit 28, and is the front-rear direction of the apparatus.

In this exemplary embodiment, for example, the extending portions 102 are provided at equal intervals in the main scanning direction. The adjoining extending portions 102 have the same width W.

As illustrated in FIG. 3, the body part 100A of the document guide 100 is located between the reading unit 28 and a placement surface 26A, on which the document G is placed, of the platen glass 26 provided on the upper surface of the document bed 22 in plan view.

The document guide 100 has a plate-like portion 104 projecting forward in the sub-scanning direction from the body part 100A. More specifically, the plate-like portion 104 projects from the body part 100A toward the right side. The plate-like portion 104 extends continuously in the main scanning direction. The plate-like portion 104 covers the end, on the backward side in the sub-scanning direction, of the platen glass 26 from above. More specifically, the plate-like portion 104 covers the left end of the platen glass 26 from above.

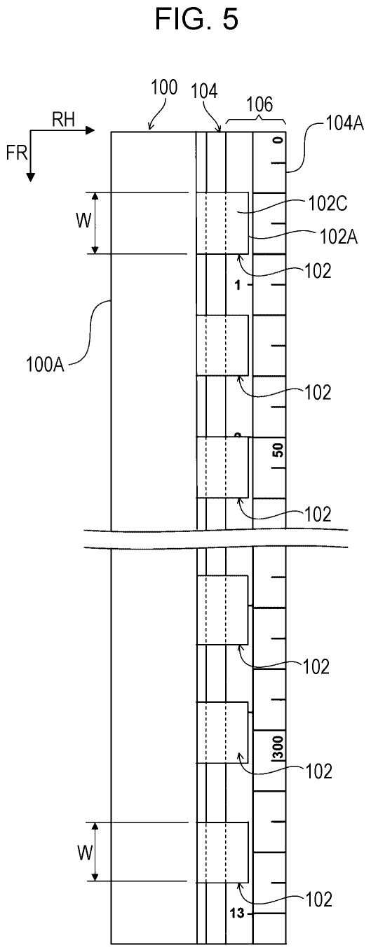

As illustrated in FIG. 5, a scale 106 indicating the size of the document G is provided on the upper surface of the plate-like portion 104. The scale 106 is provided with symbols including characters indicating the document size.

As illustrated in FIG. 3, the extending portions 102 are disposed above the plate-like portion 104. As illustrated in FIG. 4, the extending portions 102 overlap the scale 106 in plan view.

As illustrated in FIG. 3, the height of lower surfaces 102B of the extending portions 102 from the upper surface of the document bed 22 gradually increases toward the distal ends 102A. In this exemplary embodiment, the distal end 104A of the plate-like portion 104 is located further on the forward side in the sub-scanning direction than the distal ends 102A of the extending portions 102. Hence, this may also be said that the height of the lower surfaces 102B of the extending portions 102 from the upper surface of the plate-like portion 104 gradually increases forward (right side in FIG. 3) in the sub-scanning direction.

The height of the upper surfaces 102C of the extending portions 102 from the upper surface of the document bed 22 gradually increases toward the distal ends 102A. In other words, the height of the upper surfaces 102C of the extending portions 102 from the upper surface of the plate-like portion 104 gradually increases forward (right side in FIG. 3) in the sub-scanning direction.

Next, the operation of this exemplary embodiment will be described.

In this exemplary embodiment, the transport guide 90 is provided in the document feeder 30, and the document guide 100 is provided in the document bed 22. The document guide 100 guides the document G to the transport guide 90. The transport guide 90 guides the document G guided by the document guide 100 to the downstream side of the transport path R. The document guide 100 and the transport guide 90 overlap each other when viewed in the main scanning direction. In other words, the document guide 100 and the transport guide 90 have overlapping portions.

In this exemplary embodiment, the transport guide 90 has, at the upstream end 90A thereof in the transport path R direction, the notches 92 provided at intervals in the main scanning direction. The document guide 100 has the extending portions 102 provided at intervals in the main scanning direction and extending toward the downstream side of the transport path R. In a state in which the document feeder 30 is closed, the distal ends 102A of the extending portions 102 are accommodated in the notches 92, and the document guide 100 and the transport guide 90 overlap each other when viewed in the main scanning direction.

In addition, in this exemplary embodiment, the document guide 100 is located between the reading unit 28 and the placement surface 26A of the document bed 22 in plan view. The document guide 100 has the plate-like portion 104 provided with the scale 106 indicating the size of the document G.

In this exemplary embodiment, the extending portions 102 overlap the scale 106 in plan view.

In this exemplary embodiment, the lower surfaces 102B of the extending portions 102 are inclined such that the height thereof from the upper surface of the document bed 22 gradually increases toward the distal ends 102A.

In this exemplary embodiment, the upper surfaces 102C of the extending portions 102 are inclined such that the height thereof from the upper surface of the document bed 22 gradually increases toward the distal ends 102A.

### Other Exemplary Embodiments

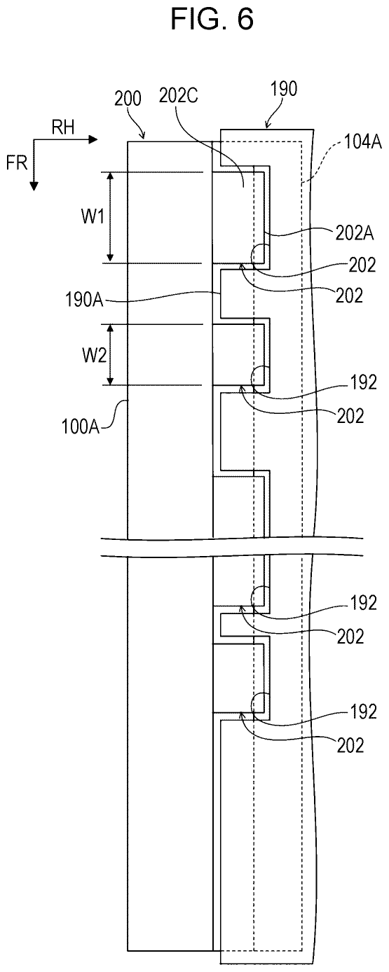

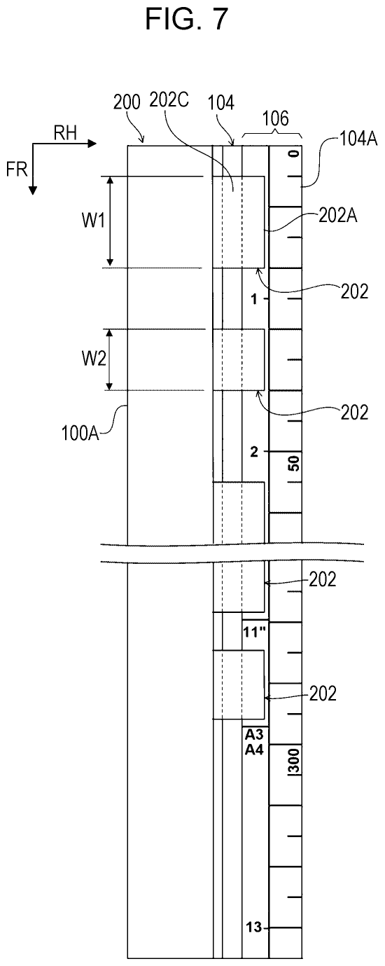

In the above-described exemplary embodiment, the extending portions 102 are provided at equal intervals in the main scanning direction, and the adjoining extending portions 102 have the same width W. However, the present disclosure is not limited to this configuration. For example, as in a transport guide 190 and a document guide 200 illustrated in FIGS. 6 and 7, the widths W1 and W2 of the adjoining extending portions 202 may be different, or the extending portions 202 may be provided at different intervals in the main scanning direction. In the exemplary embodiment illustrated in FIGS. 6 and 7, the extending portions 202 are disposed in a region where the symbols including characters indicating the document size, provided on the scale 106, are not provided.

Although the present disclosure has been described in detail with reference to the specific exemplary embodiments, the present disclosure is not limited to these exemplary embodiments. It is apparent to those skilled in the art that various other embodiments may be made within the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A document reader comprising:
a document bed having a reading part that reads a document;
a document feeder that is supported by the document bed so as to be capable of opening and closing an upper surface of the document bed and that feeds the document along a transport path passing through a reading area of the reading part;
a first guide part that is provided in the document feeder and located downstream of the reading area in the transport path and that guides the document downstream along the transport path; and
a second guide part that is provided on the upper surface of the document bed and located between the reading area and the first guide part in the transport path, that overlaps the first guide part when viewed in a main scanning direction, and that guides the document to the first guide part.
(((2)))

The document reader according to (((1))), wherein,
the first guide part has, at an upstream end thereof in a transport path direction, notches provided at intervals in the main scanning direction,
the second guide part has extending portions provided at intervals in the main scanning direction and extending toward the downstream side of the transport path, and,
in a state in which the document feeder is closed, distal ends of the extending portions are accommodated in the notches and overlap the first guide part when viewed in the main scanning direction.
(((3)))

The document reader according to (((2))), wherein the second guide part includes a plate-like portion that is located between the reading part and a placement surface on which the document is placed, the placement surface being provided on the upper surface of the document bed in plan view, and that is provided with a scale indicating a size of the document.
(((4)))

The document reader according to (((3))), wherein the extending portions overlap the scale in plan view.
(((5)))

The document reader according to (((4))), wherein a height of lower surfaces of the extending portions from the upper surface of the document bed gradually increases toward the distal ends of the extending portions.
(((6)))

The document reader according to (((5))), wherein a height of upper surfaces of the extending portions from the upper surface of the document bed gradually increases toward the distal ends of the extending portions.
(((7)))

The document reader according to any one of (((4))) to (((6))), wherein the scale is provided with symbols including characters indicating the size of the document, and
the extending portions are disposed in a region of the scale where no symbols including characters indicating the size of the document are provided.
(((8)))

The document reader according to (((7))), wherein the extending portions include a first extending portion and a second extending portion adjacent to each other, and a width of the first extending portion and a width of the second extending portion are different.
(((9)))

An image forming system comprising:
the document reader according to any one of (((1))) to (((8)); and
an image forming apparatus that forms an image on a sheet based on information read by the document reader.

What is claimed is:

1. A document reader comprising:
a document bed having a reading part that reads a document;
a document feeder that is supported by the document bed so as to be capable of opening and closing an upper surface of the document bed and that feeds the document along a transport path passing through a reading area of the reading part;
a first guide part that is provided in the document feeder and located downstream of the reading area in the transport path and that guides the document downstream along the transport path; and
a second guide part that is provided on the upper surface of the document bed and located between the reading area and the first guide part in the transport path, that overlaps the first guide part when viewed in a main scanning direction, and that guides the document to the first guide part.

2. The document reader according to claim 1, wherein:
the first guide part has, at an upstream end thereof in a transport path direction, notches provided at intervals in the main scanning direction;
the second guide part has extending portions provided at intervals in the main scanning direction and extending toward the downstream side of the transport path; and
in a state in which the document feeder is closed, distal ends of the extending portions are accommodated in the notches and overlap the first guide part when viewed in the main scanning direction.

3. The document reader according to claim 2, wherein the second guide part includes a plate-like portion that is located between the reading part and a placement surface on which the document is placed, the placement surface being provided on the upper surface of the document bed in plan view, and that is provided with a scale indicating a size of the document.

4. The document reader according to claim 3, wherein the extending portions overlap the scale in plan view.

5. The document reader according to claim 4, wherein a height of lower surfaces of the extending portions from the upper surface of the document bed gradually increases toward the distal ends of the extending portions.

6. The document reader according to claim 5, wherein a height of upper surfaces of the extending portions from the upper surface of the document bed gradually increases toward the distal ends of the extending portions.

7. The document reader according to claim 4, wherein:
the scale is provided with symbols including characters indicating the size of the document; and
the extending portions are disposed in a region of the scale where no symbols including characters indicating the size of the document are provided.

8. The document reader according to claim 7, wherein the extending portions include a first extending portion and a second extending portion adjacent to each other, and a width of the first extending portion and a width of the second extending portion are different.

9. An image forming system comprising:
the document reader according to claim 1; and
an image forming apparatus that forms an image on a sheet based on information read by the document reader.

10. An image forming system comprising:
the document reader according to claim 2; and
an image forming apparatus that forms an image on a sheet based on information read by the document reader.

11. An image forming system comprising:
the document reader according to claim 3; and
an image forming apparatus that forms an image on a sheet based on information read by the document reader.

12. An image forming system comprising:
the document reader according to claim 4; and
an image forming apparatus that forms an image on a sheet based on information read by the document reader.

13. An image forming system comprising:
the document reader according to claim 5; and
an image forming apparatus that forms an image on a sheet based on information read by the document reader.

14. An image forming system comprising:
the document reader according to claim 6; and
an image forming apparatus that forms an image on a sheet based on information read by the document reader.

15. An image forming system comprising:
the document reader according to claim 7; and
an image forming apparatus that forms an image on a sheet based on information read by the document reader.

16. An image forming system comprising:
the document reader according to claim 8; and
an image forming apparatus that forms an image on a sheet based on information read by the document reader.
